(19) United States
(12) Patent Application Publication
(10) Pub. No.: US 2014/0201271 A1
(43) Pub. Date: Jul. 17, 2014

(54) USER GENERATED RATING BY MACHINE CLASSIFICATION OF ENTITY

(71) Applicant: QUALCOMM INCORPORATED, San Diego, CA (US)

(72) Inventor: Michael William PADDON, Tokyo (JP)

(73) Assignee: QUALCOMM INCORPORATED, San Diego, CA (US)

(21) Appl. No.: 13/740,239

(22) Filed: Jan. 13, 2013

(51) Int. Cl. H04L 29/08

(52) U.S. Cl. CPC H04L 67/22
USPC 709/204

(57) ABSTRACT

Methods and systems for improving user generated ratings by machine classification of an entity are disclosed. Customer rating systems can be analyzed and the corresponding entity interaction on social media networks can be observed. A humanness rating (H value) can be assigned to an entity. The humanness rating can be determined from a multivariate function. The function's variables can be measurements of the entity's behavior on one or more social networks. The variables can be intrinsic to the entity. The variables can be based on account activity information. The variables can be based on social network information. The multivariate function can be implemented as a Bayesian classifier. The multivariate function can be implemented as a neural net. A calculated H value can be used to weigh ratings by an entity.

### BACKGROUND

1. Field

The subject matter disclosed herein relates to on line commerce systems, and more particularly to methods, apparatuses, and systems for improving user generated ratings within consumer rating systems.

2. Information

The proliferation of consumer level and business-to-business transactions over the World Wide Web is providing motivation for some to utilize unscrupulous business practices. As an example, many eCommerce and social networking websites collect and present consumer ratings associated with businesses, products, and services. A common approach is to solicit and collect numerical ratings (e.g., such as a number of “stars”). The collected ratings are then combined by a function (e.g., averaged), and the overall rating is presented to site visitors researching the business in question. As consumers rely more on such ratings services, there exists an economic incentive for businesses to subvert the process with the intent of inflating their rating. A typical attack is the creation of “sock puppet” accounts which purport to be real life consumers and who give high ratings to the sponsoring businesses. In the aggregate, multiple sock puppet accounts can skew the results of a business to show a more favorable rating than they received from actual consumers. The existence of these sock puppets, and the corresponding unscrupulous practice of providing false ratings, creates a need for mechanisms to improve the integrity and credibility of consumer rating systems on the internet.

### SUMMARY

Implementations relating to improving user generated ratings by machine classification of an entity are disclosed. In at least one implementation, a method is provided that includes determining an entity which contributes to a consumer rating, gathering information associated with the entity from a social network, generating a feature vector for the entity based at least in part on the gathered information, determining a humanness value based on the feature vector, and modifying the consumer rating based on the humanness value.

An example of a method for modifying user generated ratings according to the disclosure includes determining an entity which contributed to a user generated rating, gathering information associated with the entity from a social network, generating a feature vector for the entity based at least in part on the gathered information, determining a Humanness value based on the feature vector, and modifying the user generated rating based on the Humanness value.

Implementations of such a method may include one or more of the following features. Information associated with the entity can be intrinsic to the entity. Information associated with the entity can be related to the entity's activity in the social network. The information associated with the entity can be a measure of the entity's social network. The Humanness value can be determined by providing the feature vector to a Bayesian classifier, a neural network, and/or a Support Vector Machine. The user generated rating can be modified via a linear weighting function or a sigmoid weighting function.

An example of a computer-readable instructions for modifying a user generated rating according to the disclosure includes instructions configured to cause at least one processor to determine an entity which contributed to the user generated rating, gather information associated with the entity from a social network, generate a feature vector for the entity based at least in part on the gathered information, determine a Humanness value based on the feature vector, and modify the user generated rating based on the Humanness value.

Implementations of such computer-readable instructions may include one or more of the following features. The information associated with the entity can be intrinsic to the entity, related to the entity's activity in the social network, and a measure of the entity's social network. The Humanness value can be determined by providing the feature vector to a Bayesian classifier, to a neural network, or a Support Vector Machine. The user generated rating can be modified via a linear weighting function, or a sigmoid weighting function.

### BRIEF DESCRIPTION OF THE DRAWINGS

Non-limiting and non-exhausted aspects are described with reference to the following figures, wherein like reference numerals refer to like parts throughout the various figures unless otherwise specified.

FIG. 1 illustrates and exemplary system for improving user generated ratings by machine classification of an entity is shown.

FIG. 2 is a process flow diagram, illustrating an exemplary process for improving user generated rating by machine classification of an entity.

FIG. 3 is a process flow diagram, illustrating an exemplary process for gathering information associated with an entity from a social network.

FIG. 4 illustrates a block diagram of an example of a computer system.

### DETAILED DESCRIPTION

Implementations relating to improving user generated ratings by machine classification of an entity are disclosed. Customer rating systems can be analyzed. Entity interaction on social media networks can be observed. A humanness rating (H value) can be assigned to an entity. The humanness rating can be determined from a multivariate function. The function's variables can be measurements of the entity's behavior on one or more social networks. The variables can be intrinsic to the entity. The variables can be based on account activity information. The variables can be based on social network information. The multivariate function can be implemented as a Bayesian classifier, with the variables forming a feature vector. A set of feature vectors associated with known real humans may be used to train a real human classifier. The multivariate function can be implemented as a neural net. The net can have single output that represents the H value. The net can have multiple outputs which can be combined into the H value. A calculated H value can be used to weigh ratings by an entity.

In general, the semi-anonymous nature of Internet culture allows for the creation of “sock puppet” accounts. The fact a single user can create multiple sock puppet accounts can subvert a rating system which applies equal weight to all users. However, sock-puppets are not real people (i.e., users) and therefore can exhibit detectably divergent behavior from human beings. For example, a significant proportion of the human population of the Internet interacts publicly via social networking media (e.g, via accounts in applications such as Facebook®, Twitter®, etc. . . . ). Interactions and corresponding information within this media may be freely observed. In many cases, social networking accounts can be integrated into many consumer rating systems.

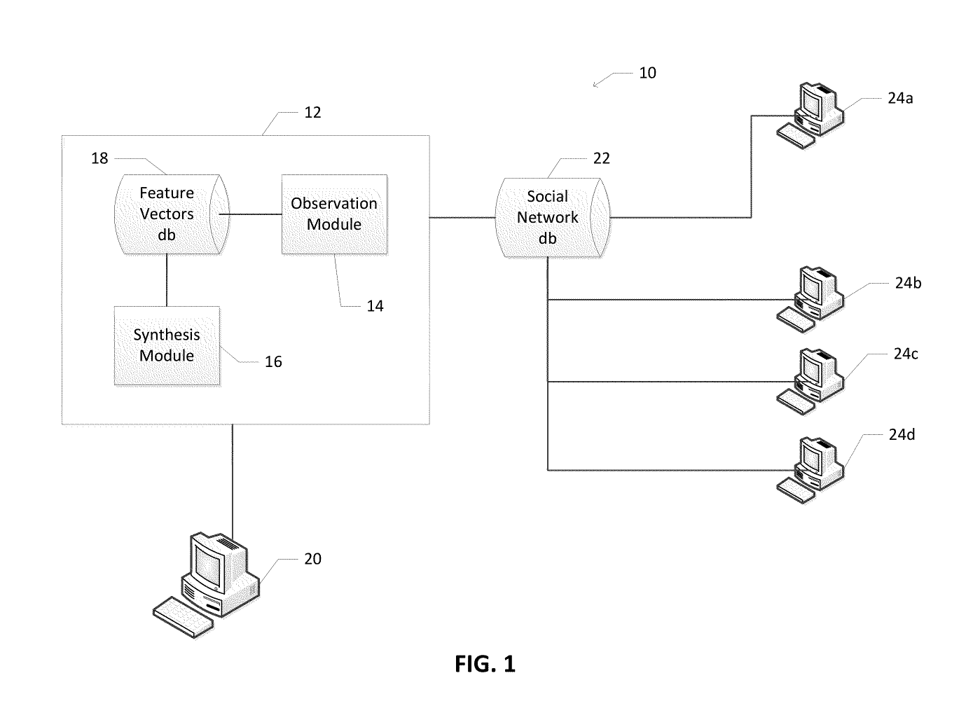

Referring to FIG. 1, a system 10 for improving user generated ratings by machine classification of an entity is shown. The system 10 can include a machine classification system 12 connected to, or operating within, a computer 20. The machine classification system 12 can include an observation module 14, a synthesis module 16, and a feature vectors database (db) 18. The machine classification system 12 can be connected to a network (e.g., the Internet) and configured to receive information from a social network 22 (e.g., FaceBook, Twitter, MySpace, BoardGameGeek, etc. . . . ). In general, the social network 22 includes information associated with multiple entities 24a-d. Typically, each social network entity 24a can be identified by an entity name (e.g., a user name, an ASCII string, a network identifier), and the information associated with each entity can be indexed by each of the corresponding entity names. As discussed herein, the term ‘entity’ can correspond to a particular user name. The observation module 14 can be configured to receive information about entities in a social network and store multivariate feature vectors for each of the entities. The synthesis module 16 can be configured to analyze these feature vectors and determine a Humanness value (i.e., H value) for each of the entities. In an embodiment, the H values can be applied to a rating system such that the scores provided by entities with a low H value can be eliminated, or reduced by a weighting factor.

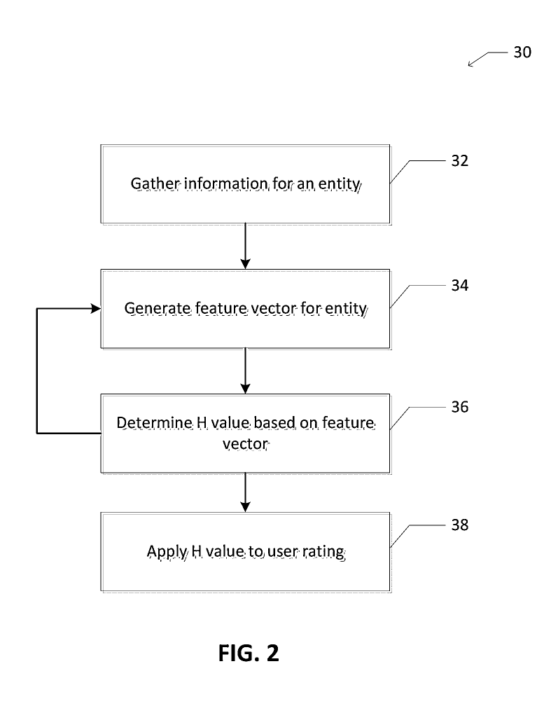

In operation, referring to FIG. 2, with further reference to FIG. 1, a process 30 for improving user generated ratings by machine classification of an entity using the system 10 includes the stages shown. The process 30, however, is exemplary only and not limiting. The process 30 may be altered, e.g., by having stages added, removed, or rearranged.

At stage 32, the observation module 14 of the system 12 can be configured to gather information related to an entity. In general, a typical implementation will include an observation phase and a synthesis phase. During the observation phase, the observation module 14 can be a computer program configured to monitor one or more social networks 22. For example, the system 12 can monitor TWITTER data streams (e.g., “tweets”), or FACEBOOK pages, or Google+ data, or any accessible social network site. The computer system 12 can evaluate the social network database 22 and collect information associated with entities. For example, the information gathered to be stored as a feature vector comprised of a collection of numerical values (e.g., a value between 0 and 1) for each attribute. As an example, and not a limitation, information associated with the entity can include attributes related to how long the account has existed; the account contact details; the richness of information within the contact details; the apparent geographic location and time zone of the entity; how often is the account utilized; the length of time between actions; the size of the postings in the account; the presence of spelling or grammatical errors in the posting, and the corresponding frequency; and the times of the postings in view of the geographical location (i.e., the time zone). Other information associated with an entity and the corresponding social network may also be gathered and stored. For example, niche networks within a social media site may also be used. The observation module 12 can be programmed to follow the links within a network (friends, friends of friends, etc. . . . ) and determine the size of that network (i.e. create a spanning tree). In general, real people tend to have large networks and sock puppets tend to have limited networks.

In an embodiment, the information gathered may be classified into general categories. For example, the gathered variables may be intrinsic to the entity, such as the age of the account, contact details, apparent geographical location of the entity. Variables may be related to the entity activity such as frequency of postings, time between postings, length of postings, frequency of spelling errors, and alignment with a time zone. The variables may be a measure of the entity's social network such as number of followers or the number of friends. The measurement of the social network may be recursive to an arbitrary depth. The variables may measure the entire network to which the entity belongs, such as total network size, and/or number of known humans who are participating.

In an embodiment the gathered information can include a recursive component. For example, if the social network includes an association to other entities (e.g., FACEBOOK friends, LINKEDIN contacts), the feature vector can include information relating to the number of connected entities, and the number of connected entities can be counted. Further, an H value for those connected entities can be captured if available.

At stage 34, the system 12 can be configured to generate a feature vector for an entity. In an embodiment, the information received from the social network 22 is indexed by the entity name. The observed information is used to construct a feature vector, V. As an example, and not a limitation, the feature vector includes real numbers that are normalized to the range [0, 1]. Other numerical range can also be used. The feature vector variables can be stored in a data structure as an appropriate data type (e.g., integer, double, float, varchar).

In an embodiment, the social network 22 can be a FACEBOOK account, and a feature vector V may include the following elements:

V[0]=bound(age-of-account-in-weeks/52)

V[1]=bound(number-of-published-email-addresses/10)

V[2]=bound(number-of-published-phone-numbers/10)

V[3]=1 if language-matches-location else 0

V[4]=bound(postings-per-minute)

V[5]=bound(posting-bytes/1,000,000)

V[6]=bound(mean(spelling-errors-per-posting)/100)

V[7]=bound(stddev(spelling-errors-per-posting)/100)

V[8]=bound(mean(grammar-errors-per-posting)/100)

V[9]=bound(stddev(grammar-errors-per-posting)/100)

V[10]=bound(mean(postings-between-0000-and-0100-localtime)/100)

V[11]=bound(stddev(postings-between-0000-and-0100-localtime)/100)

V[12]-V[34] (repeat V[11] for other 23 hours of the day]

V[35]=bound(social-network-size/10000)

V[36]=bound(degree-1-friends/1000)

V[37]=bound(degree-2-friends/1000)

V[38]=mean(H value-of-social-network)

V[39]=mean(H value-of-degree-1-friends)

V[40]=mean(H value-of-degree-2-friends)

(note: bound(x)=min(max(x, 0), 1), and mean( ) and stddev( ) have the usual meanings).

The elements of V can vary based on implementation and content of a social network. Once a feature vector is defined, it can be used to create a vector for all entities being observed. Generally, the design of a feature vector will attempt to include orthogonal vector elements to improve the performance of a classifier, but orthogonal elements are not an absolute requirement. The example includes recursion in V[38-40]. In an embodiment, when H is unknown for an entity, it is assumed to be a default value. For example, the values 0, 1, 0.5 or any other value may be chosen. Once a classifier has been used to determine H for a population, the algorithm may be run again to yield better results.

At stage 36, the synthesis module 16 can be configured to determine an H value based on the feature vector. For example, the feature vector V can be fed into a classifier. In an embodiment, reference values can be established (i.e., the classifiers can be trained) by using feature vectors for known humans and known sock puppets. When a feature vector is derived from an unknown entity and a passed through the classifier, it can be compared to the reference values. When a feature vector for an unknown entity is compared to the reference value, the system 10 can provide an H value. The H value can be used to determine if the unknown entity is either a human or not.

Typical classifiers are neural nets, Bayesian classifiers or Support Vector Machines. Using a neural net by way of example, a net with 40 input neurons (e.g., the size of V) can be defined. In an example, the net can include 2 hidden layers of 20 and 10 neurons and a single output neuron. The dimension of the net can vary and will be determined by a system designer, and would probably be tuned over time.

In general, a neural network can be trained by using two sets of data. Feature vectors (V's) where H=1 a priori, and V's where H=0. Alternatively, the network could be auto-trained with unclassified data as known in the art. Once a neural network is trained, feature vectors for other entities can be entered and their corresponding H estimates can be output. When a population is processed, their feature vectors V can be re-determined at stage 34 and an improved H value can be determined at stage 36. In an embodiment, after several iterations, the system 12 can utilize the observed V's near 1 or 0 and then use those vectors as a larger training set to train the classifier again. This process can allow for bootstrapping a much larger training set (i.e., allow the classifier to learn from experience).

At stage 38 the system 12 can be used to apply an H value to a user rating. In an embodiment, the H values can be used to weight user ratings. For example, a linear weighting function can be defined as: new-rating=rating*H. A simple sigmoid weighting function can be defined as: new-rating=rating*1/(1+ê((0.5−H)*10)). Threshold values may also be used to evaluate an H value (e.g., is an H value above or below a threshold). In general, there is a strong economic incentive to create sock puppets. It costs money to create an account to assign these ratings or provide a glowing review. The system 12 can detect the entries that do not appear human, and through the use of the H value, the user's rating can be downgraded (or eliminated) from an overall score.

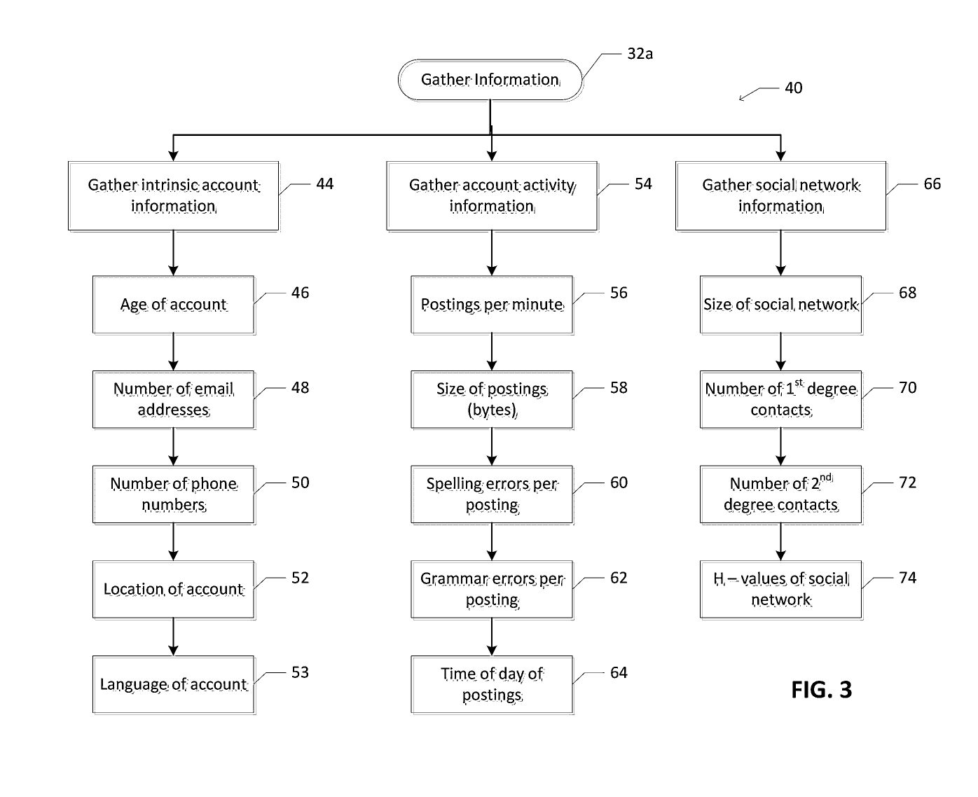

In operation, referring to FIG. 3, with further reference to FIGS. 1 and 2, a process 40 for gathering information associated with an entity from a social network using the system 10 includes the stages shown. The process 40, however, is exemplary only and not limiting. The process 40 may be altered, e.g., by having stages added, removed, or rearranged.

At stage 32a, the observation module 14 can include instructions configured to scan and store information stored in a social network database 22. The instructions can be executed at stage 32 in the process 30. For example, the social network database 22 may include an Application Programming Interface (API) and the system 12 can be configured to communicate with the database 22 via the API (e.g., stored procedure calls, SOAP, XML). In an embodiment, the observation module can be configured to crawl Uniform Resource Locator (URL) strings associated with an entity and store the information provided by the URL. Other data mining technologies may be used to obtain data from the social network database 22. The gathered information can be analyzed and stored in a feature vector that is associated with an entity.

At stage 44 the observation module 14 can be configured to gather intrinsic account information. In general, the intrinsic account information includes the elements (e.g., data fields, stored information) that relate to the nature of the entity. As examples, and not limitations, the system 12 can determine the age of an entity's account at stage 46. The age of the account can be measured in a unit of time (e.g., days, weeks, months, years) and stored as a numeric value. In general, when an account is first established, the creating entity (e.g., a user 24a) can provide contact information that is stored in the database 22. This contact information can be updated and appended during the life of the account. At stage 48, a number of emails addresses that are associated with the account can be determined and stored by the system 1. The corresponding email address can also be stored. At stage 50, information relating to the phone numbers such as the count of numbers can be stored. Other information associated with the account can be inferred if not directly stored. For example, at stage 52 the location of the account can be obtained. The location information can be input by the user, inferred from the URL, or based on the network address associated with user. Similarly, the native language that is associated with the location (e.g., popular, official) can be stored at stage 53. Other intrinsic information such as the age and gender of the user may also be gathered.

At stage 54 the system 10 can be configured to gather and analyze account activity information. In general, the account activity information includes information related to an entity's use of a social media account. As an example, and not a limitation, the content associated with a user's postings can be collected and analyzed. At stage 56 the amount of time between postings or the frequency of postings can be determined and stored. At stage 58 the size of the posting (e.g., bytes, word count) can be recorded. The content of the posts can be further analyzed and the results can be stored in the feature vector. For example, the numbers of spelling errors and grammar errors can be determined and stored at stages 60 and 62 respectively. In an embodiment, certain abbreviations associated with electronic posts and texting can be counted (e.g., LOL, OMG, TTFN). At stage 64 the local time of day of posts can be gathered and analyzed. For example, the time of the posts can be grouped into bins for each hour of the day (e.g., the number of postings between 1 am and 2 am, 2 am and 3 am, 3 am and 4 am, etc. . . . ). Other account activity may also be analyzed such as the number of pictures posted, number of user ratings entered (e.g., “Stars,” “Likes,” “Thumbs,” etc. . . . ), the number and geographic range of location related postings.

At stage 66, the system 10 can gather social network information associated with the entity. In general, the social network information relates to the number of nodes and edges that are associated with the entity. For example, the size of entity's social network can be determined at stage 68. The size of the network can include the number of first degree contacts, as determined at stage 70. The size of the network can include the number of second degree contacts, as determined at stage 72. The size of the network can include more degrees (e.g., 3^{rd}, 4^{th}). The count of contacts in each degree can be stored. In an embodiment, the contact information for each contact can be stored. At stage 74, an H value for the members of an entity's social network can be determined and utilized to determine the H value for the entity (e.g., a recursive loop). For example, feature vectors database 18 can include an H value for each entity stored in the database. If a first entity is connected to a second entity, an H value for the second entity can be looked up when gathering information for the first entity. If an H value does not exist in the database 18 for the second entity, then the system 10 can perform an evaluation on the second entity. A recursive algorithm can be used to reevaluate an entity's H value on a period basis and the H values of the entity's contacts may continue to evolve through multiple executions of the algorithm.

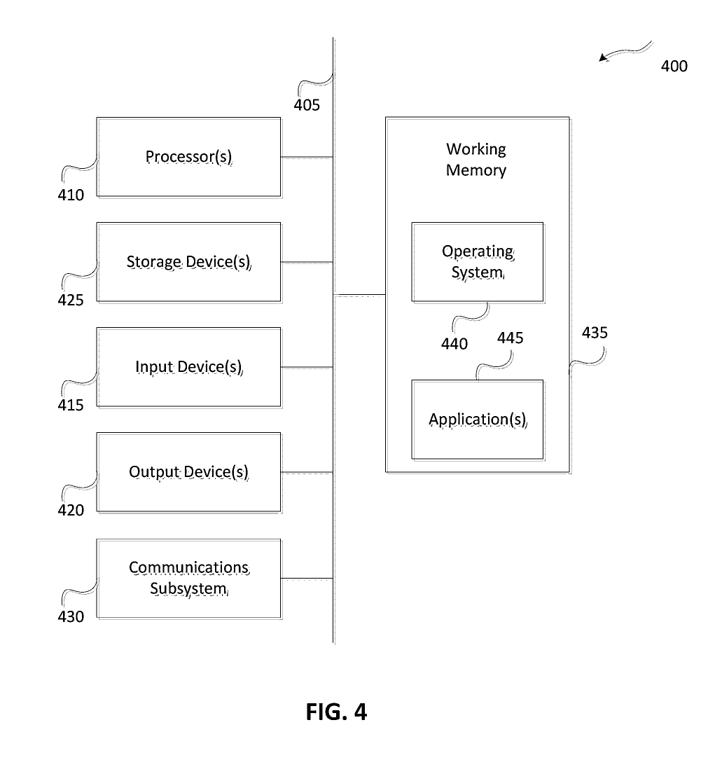

Referring to FIG. 4, with further reference to FIGS. 1-3, a computer system 400 as illustrated may incorporate as part of the previously described computerized devices. FIG. 4 provides a schematic illustration of one embodiment of a computer system 400 that can perform the methods provided by various other embodiments, as described herein, and/or can function as the host computer system, a remote kiosk/terminal, a point-of-sale device, a mobile device, and/or a computer system. It should be noted that FIG. 4 is meant only to provide a generalized illustration of various components, any or all of which may be utilized as appropriate. FIG. 4, therefore, broadly illustrates how individual system elements may be implemented in a relatively separated or relatively more integrated manner.

The computer system 400 is shown comprising hardware elements that can be electrically coupled via a bus 405 (or may otherwise be in communication, as appropriate). The hardware elements may include one or more processors 410, including without limitation one or more general-purpose processors and/or one or more special-purpose processors (such as digital signal processing chips, graphics acceleration processors, and/or the like); one or more input devices 415, which can include without limitation a mouse, a keyboard and/or the like; and one or more output devices 420, which can include without limitation a display device, a printer and/or the like.

The computer system 400 may further include (and/or be in communication with) one or more non-transitory storage devices 425, which can comprise, without limitation, local and/or network accessible storage, and/or can include, without limitation, a disk drive, a drive array, an optical storage device, solid-state storage device such as a random access memory (“RAM”) and/or a read-only memory (“ROM”), which can be programmable, flash-updateable and/or the like. Such storage devices may be configured to implement any appropriate data stores, including without limitation, various file systems, database structures, and/or the like.

The computer system 400 might also include a communications subsystem 430, which can include without limitation a modem, a network card (wireless or wired), an infrared communication device, a wireless communication device and/or chipset (such as a Bluetooth device, an 802.11 device, a WiFi device, a WiMax device, cellular communication facilities, etc.), and/or the like. The communications subsystem 430 may permit data to be exchanged with a network (such as the network described below, to name one example), other computer systems, and/or any other devices described herein. In many embodiments, the computer system 400 will further comprise a working memory 435, which can include a RAM or ROM device, as described above.

The computer system 400 also can comprise software elements, shown as being currently located within the working memory 435, including an operating system 440, device drivers, executable libraries, and/or other code, such as one or more application programs 445, which may comprise computer programs provided by various embodiments, and/or may be designed to implement methods, and/or configure systems, provided by other embodiments, as described herein. Merely by way of example, one or more procedures described with respect to the methods discussed above might be implemented as code and/or instructions executable by a computer (and/or a processor within a computer); in an aspect, then, such code and/or instructions can be used to configure and/or adapt a general purpose computer (or other device) to perform one or more operations in accordance with the described methods.

A set of these instructions and/or code might be stored on a computer-readable storage medium, such as the storage device(s) 425 described above. In some cases, the storage medium might be incorporated within a computer system, such as the system 400. In other embodiments, the storage medium might be separate from a computer system (e.g., a removable medium, such as a compact disc), and/or provided in an installation package, such that the storage medium can be used to program, configure and/or adapt a general purpose computer with the instructions/code stored thereon. These instructions might take the form of executable code, which is executable by the computer system 400 and/or might take the form of source and/or installable code, which, upon compilation and/or installation on the computer system 400 (e.g., using any of a variety of generally available compilers, installation programs, compression/decompression utilities, etc.) then takes the form of executable code.

It will be apparent to those skilled in the art that substantial variations may be made in accordance with specific requirements. For example, customized hardware might also be used, and/or particular elements might be implemented in hardware, software (including portable software, such as applets, etc.), or both. Further, connection to other computing devices such as network input/output devices may be employed.

As mentioned above, in one aspect, some embodiments may employ a computer system (such as the computer system 400) to perform methods in accordance with various embodiments of the invention. According to a set of embodiments, some or all of the procedures of such methods are performed by the computer system 400 in response to processor 410 executing one or more sequences of one or more instructions (which might be incorporated into the operating system 440 and/or other code, such as an application program 445) contained in the working memory 435. Such instructions may be read into the working memory 435 from another computer-readable medium, such as one or more of the storage device(s) 425. Merely by way of example, execution of the sequences of instructions contained in the working memory 435 might cause the processor(s) 410 to perform one or more procedures of the methods described herein.

The terms “machine-readable medium” and “computer-readable medium,” as used herein, refer to any medium that participates in providing data that causes a machine to operate in a specific fashion. In an embodiment implemented using the computer system 400, various computer-readable media might be involved in providing instructions/code to processor(s) 410 for execution and/or might be used to store and/or carry such instructions/code (e.g., as signals). In many implementations, a computer-readable medium is a physical and/or tangible storage medium. Such a medium may take many forms, including but not limited to, non-volatile media, volatile media, and transmission media. Non-volatile media include, for example, optical and/or magnetic disks, such as the storage device(s) 425. Volatile media include, without limitation, dynamic memory, such as the working memory 435. Transmission media include, without limitation, coaxial cables, copper wire and fiber optics, including the wires that comprise the bus 405, as well as the various components of the communication subsystem 430 (and/or the media by which the communications subsystem 430 provides communication with other devices). Hence, transmission media can also take the form of waves (including without limitation radio, acoustic and/or light waves, such as those generated during radio-wave and infrared data communications).

Common forms of physical and/or tangible computer-readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, EPROM, a FLASH-EPROM, any other memory chip or cartridge, a carrier wave as described hereinafter, or any other medium from which a computer can read instructions and/or code.

Various forms of computer-readable media may be involved in carrying one or more sequences of one or more instructions to the processor(s) 410 for execution. Merely by way of example, the instructions may initially be carried on a magnetic disk and/or optical disc of a remote computer. A remote computer might load the instructions into its dynamic memory and send the instructions as signals over a transmission medium to be received and/or executed by the computer system 400. These signals, which might be in the form of electromagnetic signals, acoustic signals, optical signals and/or the like, are all examples of carrier waves on which instructions can be encoded, in accordance with various embodiments of the invention.

The communications subsystem 430 (and/or components thereof) generally will receive the signals, and the bus 405 then might carry the signals (and/or the data, instructions, etc. carried by the signals) to the working memory 435, from which the processor(s) 405 retrieves and executes the instructions. The instructions received by the working memory 435 may optionally be stored on a storage device 425 either before or after execution by the processor(s) 410.

The methods, systems, and devices discussed above are examples. Various configurations may omit, substitute, or add various procedures or components as appropriate. For instance, in alternative configurations, the methods may be performed in an order different from that described, and/or various stages may be added, omitted, and/or combined. Also, features described with respect to certain configurations may be combined in various other configurations. Different aspects and elements of the configurations may be combined in a similar manner. Also, technology evolves and, thus, many of the elements are examples and do not limit the scope of the disclosure or claims.

Specific details are given in the description to provide a thorough understanding of example configurations (including implementations). However, configurations may be practiced without these specific details. For example, well-known circuits, processes, algorithms, structures, and techniques have been shown without unnecessary detail in order to avoid obscuring the configurations. This description provides example configurations only, and does not limit the scope, applicability, or configurations of the claims. Rather, the preceding description of the configurations will provide those skilled in the art with an enabling description for implementing described techniques. Various changes may be made in the function and arrangement of elements without departing from the spirit or scope of the disclosure.

Also, configurations may be described as a process which is depicted as a flow diagram or block diagram. Although each may describe the operations as a sequential process, many of the operations can be performed in parallel or concurrently. In addition, the order of the operations may be rearranged. A process may have additional steps not included in the figure. Furthermore, examples of the methods may be implemented by hardware, software, firmware, middleware, microcode, hardware description languages, or any combination thereof When implemented in software, firmware, middleware, or microcode, the program code or code segments to perform the necessary tasks may be stored in a non-transitory computer-readable medium such as a storage medium. Processors may perform the described tasks.

Having described several example configurations, various modifications, alternative constructions, and equivalents may be used without departing from the spirit of the disclosure. For example, the above elements may be components of a larger system, wherein other rules may take precedence over or otherwise modify the application of the invention. Also, a number of steps may be undertaken before, during, or after the above elements are considered. Accordingly, the above description does not bound the scope of the claims

What is claimed is:

1. A method of modifying a user generated rating, comprising:
determining an entity which contributed to the user generated rating;
gathering information associated with the entity from a social network;
generating a feature vector for the entity based at least in part on the gathered information;
determining a Humanness value based on the feature vector; and
modifying the user generated rating based on the Humanness value.

2. The method of claim 1 wherein the information associated with the entity is intrinsic to the entity.

3. The method of claim 1 wherein the information associated with the entity is related to the entity's activity in the social network.

4. The method of claim 1 wherein the information associated with the entity is a measure of the entity's social network.

5. The method of claim 1 wherein the Humanness value is determined by providing the feature vector to a Bayesian classifier.

6. The method of claim 1 wherein the Humanness value is determined by providing the feature vector to a neural network.

7. The method of claim 1 wherein the Humanness value is determined by providing the feature vector to a Support Vector Machine.

8. The method of claim 1 wherein the user generated rating is modified via a linear weighting function.

9. The method of claim 1 wherein the user generated rating is modified via a sigmoid weighting function.

10. An apparatus for modifying a user generated rating, comprising:
means for determining an entity which contributed to the user generated rating;
means for gathering information associated with the entity from a social network;
means for generating a feature vector for the entity based at least in part on the gathered information;
means for determining a Humanness value based on the feature vector; and
means for modifying the user generated rating based on the Humanness value.

11. The apparatus of claim 10 wherein the information associated with the entity is intrinsic to the entity.

12. The apparatus of claim 10 wherein the information associated with the entity is related to the entity's activity in the social network.

13. The apparatus of claim 10 wherein the information associated with the entity is a measure of the entity's social network.

14. The apparatus of claim 10 wherein the Humanness value is determined by providing the feature vector to a Bayesian classifier.

15. The apparatus of claim 10 wherein the Humanness value is determined by providing the feature vector to a neural network.

16. The apparatus of claim 10 wherein the Humanness value is determined by providing the feature vector to a Support Vector Machine.

17. The apparatus of claim 10 wherein the user generated rating is modified via a linear weighting function.

18. The apparatus of claim 10 wherein the user generated rating is modified via a sigmoid weighting function.

19. A computer-readable storage medium, having stored thereon computer-readable instructions for modifying a user generated rating, comprising instructions configured to cause at least one processor to:
determine an entity which contributed to the user generated rating;
gather information associated with the entity from a social network;
generate a feature vector for the entity based at least in part on the gathered information;
determine a Humanness value based on the feature vector; and
modify the user generated rating based on the Humanness value.

20. The computer-readable storage medium of claim 19 wherein the information associated with the entity is intrinsic to the entity.

21. The computer-readable storage medium of claim 19 wherein the information associated with the entity is related to the entity's activity in the social network.

22. The computer-readable storage medium of claim 19 wherein the information associated with the entity is a measure of the entity's social network.

23. The computer-readable storage medium of claim 19 wherein the Humanness value is determined by providing the feature vector to a Bayesian classifier.

24. The computer-readable storage medium of claim 19 wherein the Humanness value is determined by providing the feature vector to a neural network.

25. The computer-readable storage medium of claim 19 wherein the Humanness value is determined by providing the feature vector to a Support Vector Machine.

26. The computer-readable storage medium of claim 19 wherein the user generated rating is modified via a linear weighting function.

27. The computer-readable storage medium of claim 19 wherein the user generated rating is modified via a sigmoid weighting function.

28. An apparatus for modifying a user generated rating, comprising:
a non-transitory computer-readable memory;
a plurality of modules comprising processor executable code stored in the non-transitory computer-readable memory;
a processor connected to the non-transitory computer-readable memory and configured to access the plurality of modules stored in the non-transitory computer readable memory; and
an observation module configured to
determine an entity with contributed to the user generated rating;
gather information associated with entity from a social network;
generate a feature vector for the entity based at least in part on the gathered information;
a synthesis module configured to
determine a Humanness value based on the feature vector; and
modify the user generated rating based on the Humanness value.

29. The apparatus of claim 28 wherein the information associated with the entity is intrinsic to the entity.

30. The apparatus of claim 28 wherein the information associated with the entity is related to the entity activity in the social network.

31. The apparatus of claim 28 wherein the information associated with the entity is a measure of the entity's social network.

32. The apparatus of claim 28 wherein the Humanness value is determined by providing the feature vector to a Bayesian classifier.

33. The apparatus of claim 28 wherein the Humanness value is determined by providing the feature vector to a neural network.

34. The apparatus of claim 28 wherein the Humanness value is determined by providing the feature vector to a Support Vector Machine.

35. The apparatus of claim 28 wherein the user generated rating is modified via a linear weighting function.

36. The apparatus of claim 28 wherein the user generated rating is modified via a sigmoid weighting function.
